(19) United States
(12) Patent Application Publication
(10) Pub. No.: US 2023/0376558 A1
(43) Pub. Date: Nov. 23, 2023

(54) METHOD OF COMBINATORIAL OPTIMIZATION USING HYBRID TEMPORO-ATTENTIONAL BRANCHING, AND RELATED SYSTEM AND DEVICES

(71) Applicants: Mehdi SEYFI, Vancouver (CA); Amin BANITALEBI DEHKORDI, Vancouver (CA); Yong ZHANG, Richmond (CA)

(72) Inventors: Mehdi SEYFI, Vancouver (CA); Amin BANITALEBI DEHKORDI, Vancouver (CA); Yong ZHANG, Richmond (CA)

(21) Appl. No.: 17/747,778

(22) Filed: May 18, 2022

(51) Int. Cl. G06F 17/11; G06N 3/04

(52) U.S. Cl. CPC G06F 17/11; G06N 3/0481; G06N 3/0454

(57) ABSTRACT

A method of combinatorial optimization using hybrid temporo-attentional branching. Variable embeddings for the variable features, constraint embeddings for constraint features and edge embeddings for edge features are generated for each mixed integer linear program (MILP) sample in a dataset. The constraint embeddings are updated by a first graph attention network (GAT) of a neural network based on an attention of neighbouring nodes using the variable embeddings, constraint embeddings and edge embeddings. The variable embeddings are updated by a second GAT of the neural network based on an attention of neighbouring nodes using the variable embeddings, updated constraint embeddings and edge embeddings. A Gated Recurrent Unit (GRU) of the neural network generates a representation vector based on the updated variable embeddings for an input sequence consisting of all MILP samples in the dataset. Variables for a first MILP sample are selected from the representation vector in accordance with a branching policy.

### TECHNICAL FIELD

The present disclosure relates to neural networks, and more particularly to method of combinatorial optimization using hybrid temporo-attentional branching, and related system and devices.

### BACKGROUND

A mixed integer linear program (MILP) is denoted by Equation (1):

$${argmin}_{x} \{ {c}^{T} x \vert Ax \leq b , l \leq x \leq u , x ∈ {ℤ}^{p} \times {ℝ}^{n - p} \} \qquad ( 1 )$$

where c∈ [symbol] ⁿ denotes the coefficients of the linear objective, A∈ [symbol] ^{m×n} and b∈ [symbol] ^{m} respectively denote the coefficients and upper bounds of linear constraints. There are m linear constraints and n variables where p≤n is the number of integer constrained variables. x, l and u are vectors in the [symbol] ⁿ space with l and u being the lower and upper bound vectors on the variable vector x.

A feasible solution is a solution that satisfies all the constraints in Equation (1) above. The optimal solution is a solution with the optional values for the variables in the vector x. A linear programing relaxation is when the last constraint in Equation (1) is relaxed and variable x∈ [symbol] ⁿ. This turns the MILP into a Linear Program (LP). The value of the objective value of the objective function c^{T}x in the LP solution is a lower bound to the original MILP. Any lower bound for the MILP is referred to as a dual bound. The LP solution can be a feasible solution if it satisfies the integral constraints, i.e., x∈ [symbol] ^{p}× [symbol] ^{n-p}. The primal bound is the objective value of a solution that is feasible, but not necessarily optimal. This could be an upper bound to the objective value of the MILP. A MILP instance is an optimization problem in the form of Equation (1).

Branch and bound algorithm: The branch and bound algorithm which is a strong baseline for solving MILPs. It solves MILPs recursively by building a search tree at each node with partial assignment of integer values to the variables, and uses the information obtained at the node to converge to an optimal a near optimal solution. At each iteration, a leaf node is chosen to branch from (i.e., a variable to branch is chosen). The LP relaxation problem at this node is solved where the previously branched variables to be fixed at their integer value are constrained. Therefore, at each node p−r variables are relaxed where r≤p and a decision is made as to which of these variables are to be branched. The LP solution at this node provides a lower bound to the objective value of the original MILP solution as well as any further child nodes. If this lower bound is larger than the objective value of any known feasible solution, then the branch can be safely cut out of the search tree as it is guaranteed that the child nodes of this particular node will provide a larger (worse) objective value. If the LP relaxation at this node is not larger than the objective value of a known feasible solution, then the node may be expanded by selecting (branching on) a variable from the remaining (unfixed) variables at that node. Once a variable is selected, the tree is ramified into two branches and two child nodes are added to the search tree. The domain of the selected variable is divided into two non-overlapping intervals. The solution of the LP relaxation problem is chosen at the parent node for that particular variable as a reference. If xᵢ^{lp} is the LP relaxation solution of variable with index i at the parent node, the non-overlapping domains of child nodes will be x₁≥┌xᵢ^{lp}┐ and x₁≤└xᵢ^{lp}┘, where ┌⋅┐ and └⋅┘ are the ceiling and floor operators, respectively. A new MILP sample is generated from the MILP instance once branching on one variable is performed. The search tree is updated and the procedure is resumed until convergence. Linear programing is the backbone of the branch and bound algorithm. It is used for both finding the dual bounds at each node and to decide on the variable to branch with the assistance of some primal heuristics. Practically, the size of a search tree is in the exponential order with respect to the number of variables, therefore in some cases the search tree could be very large, and therefore time consuming to traverse.

The objective of combinatorial optimization is to find an optimal feasible solution within a discrete set of variables. In this context, the objective function is optimized under some constraints where a feasible solution satisfies the constraints and is at least partially integral. Combinatorial optimization in general tries to solve a resource allocation problem subject to some resource constraints. Most combinatorial optimization problems can be reduced to MILPs.

The applications of mixed integer programing are versatile. From solving scheduling problems in the transportation industry, renewable energy, telecommunication and aviation dispatching, to artificial intelligence and cloud resource allocation for minimizing the GPU cluster energy consumption with some constraints on the performance, are all applications of integer programing. Solving such problems are computationally expensive and most of the mixed integer programs are classified as NP-hard. However, there exist algorithms that perform rather well in finding the optimal solution for such complicated problems at the expense of exponential solving time with respect to the problem size. Some optimization solvers such as SCIP, CPLEX, GUROBI and etc., have been developed in the form of optimization suites with internal heuristics to solve such problems.

However, such software suites often try to solve a mixed integer program under a complex multi-stage process. For example, using the branch and bound algorithm stages such as pre-solving, node selection, processing and branching are heavily coupled with each other. On the other hand, optimization solver suites have hundreds of adjustable parameters that need to be tuned for each problem. These limitations along with availability of a huge amount of data samples at ports, supply chains, and service providing cloud instances motivate the use of statistical properties of data via utilizing artificial intelligence.

It has been proposed to mimic the primal heuristics using methods by which a feasible but not necessarily optimal solution might be found. In Learning to branch in mixed integer programming by Elias Boutros Khalil, Pierre Le Bodic, Le Song, G. Nemhauser and B. Dilkina, a branching scheme that predicts the success of running heuristics on a given node in the solutions space tree is proposed. In Accelerating primal solution findings for mixed integer programs based on solution prediction by Jian-Ya Ding, Chao Zhang, Lei Shen, Shengyin Li, Bing Wang, Yinghui Xu, Le Song, it is proposed to formulate a MILP instance as a tripartite graph base on which to train a Graph Neural Network (GNN) to predict solutions for binary variables. The basic concept behind most proposals to apply artificial intelligence to solve MILPs is imitation learning which is training a neural network that imitates full strong branching (FSB).

In view of the above and other reasons, there remains a need for an improved approach for using machine learning and artificial intelligence to solve MILPs.

### SUMMARY

The present disclosure provides a method of combinatorial optimization using hybrid temporo-attentional branching, and related system, devices and non-transitory machine-readable media. There is provided a light-weight neural network with low latency and computational complexity that utilizes the statistical properties of data which high accuracy within a timely manner. The neural network of the present disclosure provides exact combinatorial optimization using a temporo-attentional graph neural networks that mimics decisions made by solver software on branching variables. This can be contrasted with conventional solver software that typically use very complex heuristics, are very slow and time consuming, are not useable with large data sets, involve expensive simulations, and need to solve problems repeatedly.

The present disclosure provides a method of solving MILPs using neural networks trained using statistical properties of MILP instances that imitate the FSB method used in highly complex optimization solvers. Graph Attention Networks (GATs) are used in the neural network to take into account the features of the nodes and the relationships between neighboring nodes (to determine which features are important) when making branching decisions. The temporal history of branching decisions may also be taken into account with a Gated Recurrent Unit (GRU). Temporal variations of the features generated by optimization solvers provide extra information and can be important in the branching policy in order to make an optimal decision. A hybrid system is provided to use the combinations of both the heuristics and a trained GNN to solve MILP instances.

The method of the present disclosure uses a temporal history of the environment variables, constraints and edge features, and distills the features into a sequence of representation vectors. The correlation among the sequence of representation vectors is used by a neural network to learn the temporal information between samples. At inference time, the neural network makes decisions based on the information from individual environment variables, constraints and edge features as well as the temporal correlation between these features.

Advantageously, the method of the present disclosure improves branching accuracy, reduces branching time, and is not dataset dependent design wise. The method of the present disclosure also increases the convergence speed and accuracy. The method of the present disclosure also increases the dual integral bound reward described below.

The method of the present disclosure can be used to solve mixed integer linear programs (MILP). The method of the present disclosure can be used to address a variety of problems and applications relating to, among other things, cellular networks, telecommunication networks, scheduling (e.g., in transportation industry), renewable energy, aviation dispatching, and artificial intelligence and/or cloud resource allocation (for example, for minimizing the GPU cluster energy consumption with some constraints on the performance). With respect to cellular networks, the method of the present disclosure may be used to distribute available frequencies across antennas in a cellular network so as to connect mobile equipment and minimize interference between the antennas. This problem can be formulated as an integer linear program in which binary variables indicate whether a frequency is assigned to an antenna. With respect to telecommunication networks, the goal of these problems is to design a network of lines to install so that a predefined set of communication requirements are met and the total cost of the network is minimal. This requires optimizing both the topology of the network along with the setting the capacities of the various lines. In many cases, the capacities are constrained to be integer quantities. Usually there are, depending on the technology used, additional restrictions that can be modeled as linear inequalities with integer or binary variables. With respect to scheduling, these problems involve service and vehicle scheduling in transportation networks. For example, a problem may involve assigning buses or subways to individual routes so that a timetable can be met, and also to equip them with drivers. Here binary decision variables indicate whether a bus or subway is assigned to a route and whether a driver is assigned to a particular train or subway. With respect to AI in resource allocation on cloud computing platforms, the methods of the present disclosure can be used with a cloud AI platform to access GPU clusters for training AI models on the cloud computing platforms. With cost efficient deep learning job allocation (CE-DLA), energy consumption of deep learning clusters can be minimized while maintaining the overall system performance within an acceptable threshold. The methods of the present disclosure can be used to optimally allocate the GPU clusters to the users while minimizing the energy consumption cost.

In accordance with a first aspect of the present disclosure, there is provided a computer-implemented method for solving combinatorial optimization using a neural network, comprising: receiving a dataset comprising a first mixed integer linear program (MILP) sample and a predetermined number of other MILP samples of a MILP instance represented by a bipartite graph, wherein the bipartite graph consists of a group of variable nodes, a group of constraint nodes, and edges between nodes in the group of variable nodes and the group of constraint nodes, each MILP sample comprising a variable feature vector comprising variable features, a constraint feature vector comprising constraint features and an edge feature vector comprising edge features; for each MILP sample in the dataset: generating variable embeddings, constraint embeddings and edge embeddings for the variable features, constraint features and edge features, respectively; updating, by a first graph attention network (GAT) of the neural network, the constraint embeddings based on an attention of neighbouring nodes using the variable embeddings, constraint embeddings and edge embeddings; and updating, by a second GAT of the neural network, the variable embeddings based on an attention of neighbouring nodes using the variable embeddings, updated constraint embeddings and edge embeddings; generating, by a Gated Recurrent Unit (GRU) of the neural network, a representation vector based on the updated variable embeddings for an input sequence consisting of all MILP samples in the dataset; and selecting variables for the first MILP sample from the representation vector in accordance with a branching policy.

In some or all examples of the first aspect, the constraint embeddings are updated by the first GAT of the neural network by determining each constraint node in accordance with the following equation:

$${c}_{i , t} = \frac{1}{H} ( {α}_{ii}^{( h )} {Θ}_{c}^{( h )} {c}_{i , t} + {\sum }_{j ∈ {N}_{i}} {α}_{ij}^{( h )} {Θ}_{v}^{( h )} {v}_{j , t} ) \\ where \\ {α}_{ij}^{( h )} = \frac{exp ( {a}_{c}^{{( h )}^{T}} LeakyReLU ( [ {Θ}_{c}^{( h )} {c}_{i , t} \vert \vert {Θ}_{v}^{( h )} {v}_{j , t} \vert \vert {Θ}_{e}^{( h )} {e}_{ij , t} ] ) )}{{Σ}_{k ∈ {N}_{i} ⋃ \{ i \}} exp ( {a}_{c}^{{( h )}^{T}} LeakyReLU ( [ {Θ}_{c}^{( h )} {c}_{i , t} \vert \vert {Θ}_{v}^{( h )} {v}_{j , t} \vert \vert {Θ}_{e}^{( h )} {e}_{ij , t} ] ) )} ,$$

where Θᵥ^{(h)}∈ [symbol] ^{d′×d} is a learned weight
where, Θ_{c}^{(h)}∈ [symbol] ^{d′×d} is a learned weight,
where, Θₑ^{(h)}∈ [symbol] ^{d′×d} is a learned weight,
where a_{c}^{(h)} is an attention coefficients vector with a_{c}^{(h)}∈ [symbol] ^{3d′}.

In some or all examples of the first aspect, the variable embeddings are updated by the second GAT of the neural network by determining each variable node in accordance with the following equation:

$${v}_{j , t} = \frac{1}{H} {\sum }_{h = 1}^{H} ( {β}_{jj}^{( h )} {Ψ}_{v}^{( h )} {v}_{j , t} + {\sum }_{i ∈ {N}_{j}} {β}_{ji}^{( h )} {Ψ}_{c}^{( h )} {c}_{i , t} ) \\ where \\ {β}_{ji}^{( h )} = \frac{exp ( {a}_{v}^{{( h )}^{T}} LeakyReLU ( [ {Ψ}_{v}^{( h )} {v}_{j , t} \vert \vert {Ψ}_{c}^{( h )} ∈ {ℝ}^{d \times d} {c}_{i , t} \vert \vert {Ψ}_{ve}^{( h )} ∈ {ℝ}^{d \times d} {e}_{ji , t} ] ) )}{{Σ}_{k ∈ {N}_{j} ⋃ \{ j \}} exp ( {a}_{v}^{{( h )}^{T}} LeakyReLU ( [ {Ψ}_{v}^{( h )} {v}_{j , t} \vert \vert {Ψ}_{c}^{( h )} ∈ {ℝ}^{d \times d} {c}_{i , t} \vert \vert {Ψ}_{ve}^{( h )} ∈ {ℝ}^{d \times d} {e}_{ji , t} ] ) )} ,$$

where Ψ_{c}^{(h)}∈ [symbol] ^{d×d′} is a learned weight,
where Ψᵥ^{(h)}∈ [symbol] ^{d×d} is a learned weight,
where Ψₑ^{(h)}∈ [symbol] ^{d×d} is a learned weight,
where aᵥ^{(h)}∈ [symbol] ^{3d} is a learned attention coefficients vector, the variable feature nodes v_{i,t} represent each variable in the bipartite graph ∀i∈[0,n], wherein the variable feature nodes are encoded representations regarding the graph structure and node embeddings of the MILP instance at a state sₜ.

In some or all examples of the first aspect, the GRU is a multi-layer GRU recurrent neural network (RNN).

In some or all examples of the first aspect, the representation vector is generated by the GRU of the neural network by, for each variable node v_{i,t} in the input sequence and t∈{t−L+1, . . . , t}, computing the following equations:

z_{i,t}=σ_{g}(W_{z},v_{i,t}+U_{z}hₜ₋₁+b_{z}),

r_{i,t}=σ_{g}(Wᵣv_{i,t}+Uᵣh_{i,t-1}+bᵣ),

ĥₜ=Øₕ(Wₕv_{i,t}+Uₕ(r_{i,t}⊙h_{i,t-1})+bₕ),

h_{i,t}=(1−z_{i,t})⊙h_{i,t-1}+z_{i,t}└ĥₜ,
where L is a GRU length, ⊙ is a Hadamard product operator, hₜ∈ [symbol] d″ is the representation vector, ĥₜ∈ [symbol] d″ is a candidate activation vector, zₜ∈ [symbol] d″ is a update gate vector, rₜ∈ [symbol] d″ is a reset gate vector, W, U∈ [symbol] ^{d″×d} and b∈ [symbol] ^{d″} are GRU parameter matrices and vector respectively, and σ_{g} and ϕₕ are sigmoid and hyperbolic tangent activation functions.

In some or all examples of the first aspect, the variables for the first MILP sample are selected from the representation vector in accordance with the branching policy with the following equation:

$${π}_{θ} ( {a}_{t}^{*} \vert {s}_{t} , … , {s}_{t + 1 - L} ) = {argmax}_{i} \frac{exp ( {F}_{V} ( {h}_{i , t} ) )}{{Σ}_{j = 1 \neq i}^{n} exp ( {F}_{V} ( {h}_{j , t} ) )} ,$$

where Fᵥ: [symbol] ^{d″}→ [symbol] is a multi-layer perceptron.

In some or all examples of the first aspect, the method comprises: extracting the variable features, constraint features and edge features from the MILP samples.

In some or all examples of the first aspect, the variable features, constraint features and edge features are extracted using information about an application environment associated with the MILP instance.

In some or all examples of the first aspect, the application environment comprises cellular networks, telecommunication networks, scheduling, renewable energy, aviation dispatching, or artificial intelligence and/or cloud resource allocation.

In some or all examples of the first aspect, the variable features, constraint features and edge features are extracted by a solver application separate from the neural network.

In some or all examples of the first aspect, the method comprises: normalizing the dataset prior to generating the based on the variable embeddings, constraint embeddings and edge embeddings.

In some or all examples of the first aspect, the method comprises: determining a label or classification based on the selected variables.

In some or all examples of the first aspect, the method comprises: outputting the selected variables or a label or classification determined based on the selected variables to an external system for application thereon.

In some or all examples of the first aspect, the method comprises: applying the selected variables or a label or classification determined based on the selected variables to a system.

In some or all examples of the first aspect, the selected variables or label or classification determined based on the selected variables are applied to a system for associated with cellular networks, telecommunication networks, scheduling, renewable energy, aviation dispatching, or artificial intelligence and/or cloud resource allocation.

In some or all examples of the first aspect, the selected variables or label or classification determined based on the selected variables are applied to distribute available frequencies across antennas in a cellular network so as to connect mobile equipment and that interference between the antennas in the cellular network is minimized.

In some or all examples of the first aspect, the selected variables or label or classification determined based on the selected variables are applied to a determine network lines of a telecommunication network so that so that a predefined set of communication requirements are met and a total cost of the telecommunication network is minimized.

In some or all examples of the first aspect, the selected variables or label or classification determined based on the selected variables are applied to cost efficient deep learning job allocation (CE-DLA), wherein energy consumption of deep learning clusters is minimized while maintaining an overall system performance within an acceptable threshold.

In accordance with another aspect of the present disclosure, there is provided a computing device comprising one or more processors and a memory. The memory having tangibly stored thereon executable instructions for execution by the one or more processors. The executable instructions, in response to execution by the one or more processors, cause the computing device to perform the methods described above and herein.

In accordance with a further aspect of the present disclosure, there is provided a non-transitory machine-readable medium having tangibly stored thereon executable instructions for execution by one or more processors. The executable instructions, in response to execution by the one or more processors, cause the one or more processors to perform the methods described above and herein.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

FIG. 1 is a block diagram of an example simplified computing system that may be used in accordance with example embodiments of the present disclosure.

FIGS. 2A and 2B are bipartite graph representations of mixed integer linear program (MILPs).

FIG. 3 is example bipartite graph representing a MILP instance of 3 variables and 4 constraints.

FIGS. 4(a) and (b) are bipartite graph representation illustrating the interplay between nodes.

FIG. 5 is a schematic block diagram of a branching module for a neural network for solving MILP instances using attentional branching in accordance with an embodiment of the present disclosure.

FIG. 6 is a schematic block diagram of a neural network using hybrid temporo-attentional branching in accordance with an embodiment of the present disclosure.

FIG. 7A illustrates a flowchart of a method for solving a mixed integer linear program in accordance with an example embodiment of the present disclosure.

FIG. 7B illustrates a flowchart of a method for training a neural network to solve a mixed integer linear program in accordance with an example embodiment of the present disclosure.

FIG. 8A is schematic block diagram of an artificial intelligence (AI) solver for solving MILPs using hybrid temporo-attentional branching in accordance with an embodiment of the present disclosure.

FIG. 8B is an example user interface of a cloud AI based system for solving MILPs using hybrid temporo-attentional branching in accordance with an embodiment of the present disclosure.

FIG. 9 shows experimental results using four benchmark datasets compared to baselines in three segments of datasets designated easy, medium, and hard.

FIG. 10 shows a dual-primal gap across the baselines and the method of the present disclosure.

FIG. 11 shows experimental results using a dual integral reward metric for a maritime inventory routing dataset/benchmark.

FIG. 12 shows experimental results using a dual integral reward metric for a load balancing dataset/benchmark.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

The following acronyms and Abbreviations are used in the present disclosure:

| | Acronym/Abbreviation/Initialism |
|---|---|
| AI | Artificial Intelligence |
| MILP | Mixed Integer Linear Programs |
| LP | Linear program |
| GAT | Graph Attention Network |
| GRU | Gated Recurrent Unit |
| NN | Neural Network |
| GNN | Graph Neural Network |
| MLP | Multi-Layer Perception |
| B&B | Branch and Bound |
| FSB | Full Strong Branching |
| PSE or PB | PseudoCost Branching |
| BM | Branching Module |
| MPN | Message Passing Network |
| RNN | Recurrent Neural Network |
| LSTM | Long Short term Memory |
| SaaS | Software as a Service |
| SCIP | Solving Constraint Integer Programs |
| GPU | Graphics Processing Unit |
| CPU | Central Processing Unit |
| CE-DLA | Cost efficient deep learning job allocation |
| NP | non-deterministic polynomial-time |

Within the present disclosure, the following definitions are used. The term “instance” means a single MILP. The term “sample” means a sample of an instance. Each instance is sampled to many iterations until the solver either solves the MILP instance or reaches a time limit in solving the instance. The term “LP relaxation” means when an integer constraint on variables is removed. The term “dual bound” means a lower bound to the MILP problem obtained by LP relaxation. The term “primal bound” means an objective value of a solution that is feasible but not necessarily optimal. The term “objective value” means the value of the objective function when evaluated at a certain point. The term “feasible solution” means a solution that satisfies all the constraints in a MILP but is not necessarily optimal.

Within the present disclosure, the terms “combinatorial optimization problems” and “mixed integer programs” are used interchangeably.

### Example Computing System

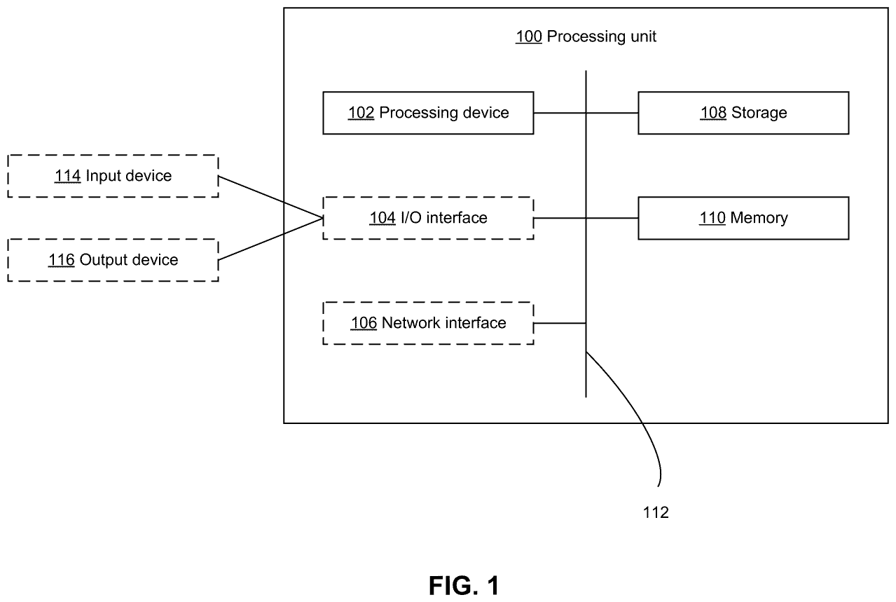

FIG. 1 illustrates a block diagram of an example simplified computing system 100, which may be a device that is used to solve mixed integer linear programs in accordance with examples disclosed herein. Other computing systems suitable for implementing embodiments described in the present disclosure may be used, which may include components different from those discussed below. In some examples, the computing system 100 may be implemented across more than one physical hardware unit, such as in a parallel computing, distributed computing, virtual server, or cloud computing configuration. Although FIG. 1 shows a single instance of each component, there may be multiple instances of each component in the computing system 100.

The computing system 100 may include one or more processing device(s) 102, such as a central processing unit (CPU) with a hardware accelerator, a graphics processing unit (GPU), a tensor processing unit (TPU), a neural processing unit (NPU), a microprocessor, an application-specific integrated circuit (ASIC), a field-programmable gate array (FPGA), a dedicated logic circuitry, a dedicated artificial intelligence processor unit, or combinations thereof.

The computing system 100 may also include one or more optional input/output (I/O) interfaces 104, which may enable interfacing with one or more optional input devices 114 and/or optional output devices 116. In the example shown, the input device(s) 114 (e.g., a keyboard, a mouse, a microphone, a touchscreen, and/or a keypad) and output device(s) 116 (e.g., a display, a speaker and/or a printer) are shown as optional and external to the computing system 100. In other examples, one or more of the input device(s) 114 and/or the output device(s) 116 may be included as a component of the computing system 100. In other examples, there may not be any input device(s) 114 and output device(s) 116, in which case the I/O interface(s) 104 may not be needed.

The computing system 100 may include one or more optional network interfaces 106 for wired or wireless communication with a network (e.g., an intranet, the Internet, a P2P network, a WAN and/or a LAN) or other node. The network interfaces 106 may include wired links (e.g., Ethernet cable) and/or wireless links (e.g., one or more antennas) for intra-network and/or inter-network communications.

The computing system 100 may also include one or more storage units 108, which may include a mass storage unit such as a solid state drive, a hard disk drive, a magnetic disk drive and/or an optical disk drive. The computing system 100 may include one or more memories 110, which may include a volatile or non-volatile memory (e.g., a flash memory, a random access memory (RAM), and/or a read-only memory (ROM)). The non-transitory memory(ies) 110 may store instructions for execution by the processing device(s) 102, such as to carry out examples described in the present disclosure. The memory(ies) 110 may include other software instructions, such as for implementing an operating system and other applications/functions. In some examples, memory 110 may include software instructions for execution by the processing device 102 to train a neural network and/or to implement a trained neural network, as disclosed herein.

In some other examples, one or more data sets and/or modules may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 112 providing communication among components of the computing system 100, including the processing device(s) 102, optional I/O interface(s) 104, optional network interface(s) 106, storage unit(s) 108 and/or memory(ies) 110. The bus 112 may be any suitable bus architecture including, for example, a memory bus, a peripheral bus or a video bus.

### Combinatorial Optimization Using Hybrid Temporo-Attentional Branching

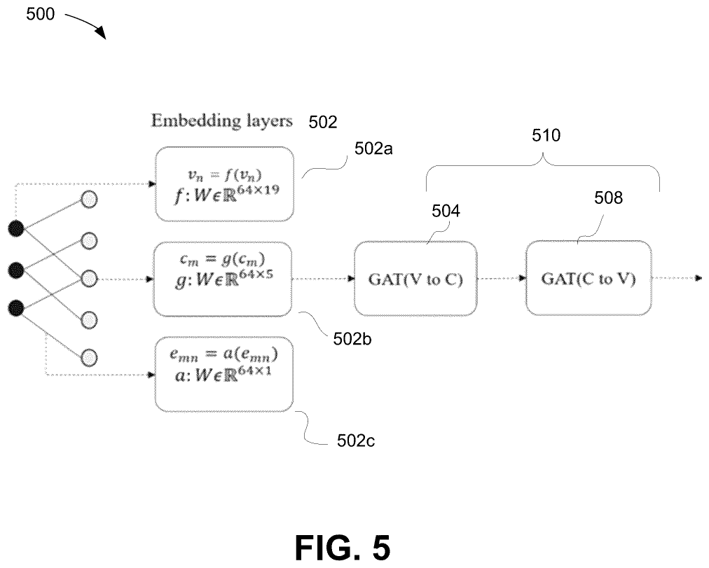

FIG. 5 is a schematic block diagram of a branching module 500 for a network for solving MILP instances using attentional branching in accordance with an embodiment the present disclosure. The branching module 500 comprises embedding layers 502 and a pair of graph attention networks (GATs) (also referred to as GAT modules) denoted 504 and 508 respectively and 510 collectively.

The variable features, constraint features and edge features of the bipartite graph are each passed through an embedding layer 502 to encode the variable features, constraint features and edge features of the bipartite graph respectively. An embedding layer 502a encodes the variable features, an embedding layer 502b encodes the constraint features, and an embedding layer 502c encodes the edge features of the bipartite graph. A normalization module may be provided prior to each embedding layer, for example, to normalize each feature value to be between 0 and 1 using a normalization technique known in the art. The embedding layers 502 generates a feature vector of the same size so the feature vectors can be mixed by the branching module 500 through attention modules in the form of GATs 504, 508. In some examples, the embedding layers 502 are a simple MLP with rectified linear activation unit (RELU) activation functions.

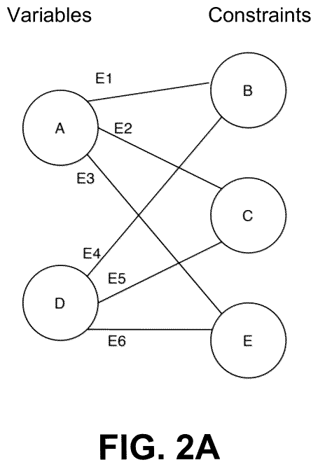

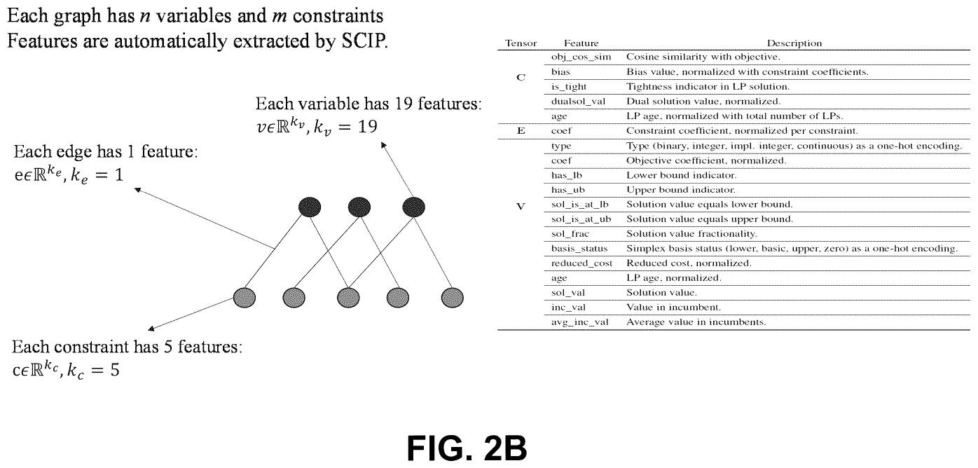

As part of the method of solving a MILP, a representation of the MILP as a bipartite graph is generated. The bipartite graph representation of the MILP may be provided as input or automatically generated. FIG. 2A is an illustration of a bipartite graph representation of a mixed integer linear program (MILP). The bipartite graph consists of two groups of nodes such that there are no edges between nodes within the same group. The only edges are between nodes in the two different groups. In FIG. 2A, nodes A and D form a first group denoted Variables and nodes B, C and E form a second group denoted Constraints. Edges E1, E2 and E3 are formed between node A in the Variables group and nodes B, C and D in the Constraints group. Conversely, edges E4, E5 and E6 are formed between node D in the Variables group and nodes B, C and E in the Constraints group. Each bipartite graph has n variables and m constraints, each of which are represented by a corresponding node. The variables, constraints and edges each have one or more features. The bipartite graph variable features, constraint features, and edge features may be automatically generated, for example, by solving software such as SCIP (Solving Constraint Integer Program), examples are known in the art. FIG. 2B is an illustration of a bipartite graph representation of a MILP in which each variable has 19 features, each constraint has 5 features, and each edge has 1 feature.

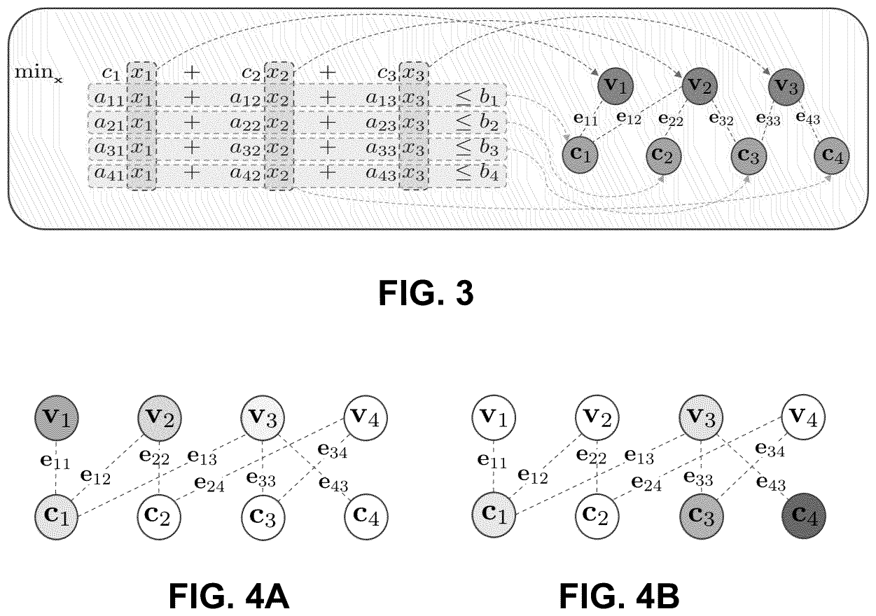

Sequential variable selections for the MILP represented by a bipartite graph are made by the branch and bound (B&B) algorithm are modelled by a Markov decision process. The solver state at the t^{th} decision is denoted sₜ and contains information about the current dual bound, primal bound, the LP solution of each node, the currently focused leaf node, etc. During an episode the agent, based on the environment variables, and a selection policy π_{θ}(⋅), selects a variable at amongst all the fractional variables of the MILP, performs the branching-and-bounding as described above, and moves to the next state sₜ₊₁. Each state of the sₜ of the B&B Markov decision process at time slot t is modelled as a bipartite graph denoted by ( [symbol] , Cₜ, Vₜ, Eₜ) where is the [symbol] is the bipartite graph, Cₜ is the constraint features at time slot t, Vₜ is the variable features at time slot t, and Eₜ is the edge features at time slot t. A first set of n graph nodes represent variables x∈ [symbol] ⁿ and the other set of m nodes represent the constraints. Variable xⱼ in the MILP instance is represented by a node feature vector v_{j,t}∈ [symbol] ^{k}^{ᵥ} and the i^{th} constraint, on the other hand, is represented by a node feature vector c_{i,t}∈ [symbol] ^{k}^{_{c}}. Node c_{i,t} is connected to the node v_{j,t} via the edge e_{ij,t}∈ [symbol] ^{k}^{ₑ} if and only if aᵢⱼ≠0. The vectors representing each node or edge are obtained by extracting features about the node or edge from the application environment. The application environment may comprise, for example, cellular networks, telecommunication networks, scheduling, renewable energy, aviation dispatching, or artificial intelligence and/or cloud resource allocation. The features may be learned or optimized from data, or hand-crafted based on rules-based feature extraction methods developed through human experience. Example features include type of variables (binary, integer, etc.), dual solution value, objective coefficients, lower bound and upper bound indicators, reduced cost, etc. It will be appreciated that the feature vectors in FIG. 5 are shown as having a particular size but this is merely an example. The feature vectors each have a size of a×b, where a is the size of the vector (a=64 in the shown example) and b is the number of features for variables, constraints and edges respectively (b=19, b=5, b=1 in the shown example). FIG. 3 is a bipartite graph representing a MILP instance of 3 variables and 4 constraints. In this example, the MILP instance a₁₃=a₂₁=a₃₁=a₄₁=0. Therefore, there is no connecting edge between their representing graph nodes.

The bipartite representation of the state is denoted by sₜ, where Cₜ∈ [symbol] ^{m×k}^{_{c}}, Vₜ∈ [symbol] ^{n×k}^{ᵥ} and Eₜ∈ [symbol] ^{m×n×k}^{ₑ}. To increase the capacity and to be able to change the node interactions, embedding layers are used to map each node and edge to space [symbol] ^{d}. For brevity and simplicity of notation, it is assumed that the embedding layers are already applied to ( [symbol] , Cₜ, Vₜ, Eₜ) and therefore, (c_{i,t}, v_{j,t}, e_{ij,t})∈ [symbol] ^{d×d×d}, ∀(c_{i,t}, v_{j,t}, e_{ij,t})∈ [symbol] .

### Attention Mechanism

Neighborhood normalization is considered to be useful for improving results. The rational behind neighborhood normalization is that higher degree neighbors may be bearing more generic and less precise information in some cases; therefore, less importance should be place on such nodes. On the other hand, in other cases normalization may lead to loss of information by removing key structural information from the graph nodes. Specifically, the embeddings learned from nodes with different degrees may be indistinguishable. Intuitively, some kind of node normalization for a bipartite graph representation of a MILP instance may be justifiable. The variables participating in many constraints may be less information bearing than the ones engaging in only a few. At the same time, by normalizing the node degrees, some structural information from the bipartite graph representation [symbol] may be removed.

FIGS. 4(a) and (b) are bipartite graph representation illustrating the interplay between nodes and how variables participating in many constraints may be less information bearing than the ones engaging in only a few. Referring to FIG. 4(a), intuitively, since v₁ only appears in the first constraint; therefore c₁ attends to v₁ more, rather than v₃ that participates in multiple constraints. It is mainly because the information about v₃ flows in the graph not only via its connection to c₁ but also via other connecting nodes to v₃ other than c₁. In FIG. 4 (b), with a similar intuition v₃ attends to c₄ the most and c₂ the least. In both figures, a darker shade means more attention.

The neural network, methods and systems and media of the present disclosure use an attention mechanism to extract information associated with the interplay between neighboring nodes. By using attention, the freedom to prioritize each node according to its neighborhood structure and embedding features is provided by the model. This allows the amount of participation a node has in a branching policy to be determined. Considering the bipartite nature of [symbol] , a pair of back-to-back attention structures are used to encode node interactions.

Because the features associated with one node may be more important in the final branching decision than another node, a GAT learns how much attention is paid to a certain node in the neighborhood. At inference time, the GAT weights the neighborhood based on the importance in a branching policy decision. In the branching module 500, the attention structures are provided by the GATs 504, 508, which are arranged in sequence in a back-to-back manner. The input to the GATs 504, 508 are the environment variable features, constraint features, and edge features. The first GAT 504 updates the constraint features and the second GAT 508 updates the variable features. The variable features are used to generate a representation vector.

Each constraint node c_{i,t} attends to its neighborhood [symbol] in the first round via an attention structure with number of H attention heads, and is determined using equation (2):

$${c}_{i , t} = \frac{1}{H} {\sum }_{h = 1}^{H} ( {α}_{ii}^{( h )} {Θ}_{c}^{( h )} {c}_{i , t} + {\sum }_{i ∈ {N}_{i}} {α}_{ij}^{( h )} {Θ}_{v}^{( h )} {v}_{j , t} ) \qquad ( 2 )$$

with learnable weights Θᵥ^{(h)}, Θ_{c}^{(h)}∈ [symbol] ^{d′×d}. The updated constraint embeddings are averaged across multiple attention heads using equation (3):

$${α}_{ij}^{( h )} = \frac{exp ( {a}_{c}^{{( h )}^{T}} LeakyReLU ( [ {Θ}_{c}^{( h )} {c}_{i , t} \vert \vert {Θ}_{v}^{( h )} {v}_{j , t} \vert \vert {Θ}_{e}^{( h )} {e}_{ij , t} ] ) )}{{Σ}_{k ∈ {N}_{i} ⋃ \{ i \}} exp ( {a}_{c}^{{( h )}^{T}} LeakyReLU ( [ {Θ}_{c}^{( h )} {c}_{i , t} \vert \vert {Θ}_{v}^{( h )} {v}_{k , t} \vert \vert {Θ}_{e}^{( h )} {e}_{ik , t} ] ) )} \qquad ( 3 )$$

where, Θₑ^{(h)}∈ [symbol] ^{d′×d} and the attention coefficients vector a_{c}^{(h)}∈ [symbol] ^{3d′} are automatically learned to encode both feature level and structure level information flow in the graph and II denotes vector concatenation. Similarly, the variable nodes are encoded using equation (4):

$${v}_{j , t} = \frac{1}{H} {\sum }_{h = 1}^{H} ( {β}_{jj}^{( h )} {Ψ}_{v}^{( h )} {v}_{j , t} + {\sum }_{i ∈ {N}_{j}} {β}_{ji}^{( h )} {Ψ}_{c}^{( h )} {c}_{i , t} ) \qquad ( 4 )$$

with learnable weights Ψ_{c}^{(h)}∈ [symbol] ^{d×d′}, and Ψᵥ^{(h)}∈ [symbol] ^{d×d}. βⱼᵢ^{(h)} is determined using equation (5):

$${β}_{ji}^{( h )} = \frac{exp ( {a}_{v}^{{( h )}^{T}} LeakyReLU ( [ {Ψ}_{v}^{( h )} {v}_{j , t} \vert \vert {Ψ}_{c}^{( h )} ∈ {ℝ}^{d \times d} {c}_{i , t} \vert \vert {Ψ}_{ve}^{( h )} ∈ {ℝ}^{d \times d} {e}_{ji , t} ] ) )}{{Σ}_{k ∈ {N}_{j} ⋃ \{ j \}} exp ( {a}_{v}^{{( h )}^{T}} LeakyReLU ( [ {Ψ}_{v}^{( h )} {v}_{j , t} \vert \vert {Ψ}_{c}^{( h )} ∈ {ℝ}^{d \times d} {c}_{i , t} \vert \vert {Ψ}_{ve}^{( h )} ∈ {ℝ}^{d \times d} {e}_{ji , t} ] ) )} \qquad ( 5 )$$

where Ψₑ^{(h)}∈ [symbol] ^{d×d} is learnable and aᵥ^{(h)}∈ [symbol] ^{3d} is the learned attention coefficients vector. The feature nodes v_{i,t} represent each variable in the graph ∀i∈[0,n]. These encoded representations hold information about the graph structure and node embeddings of the MILP instance at the state sₜ.

### Temporal Encoding

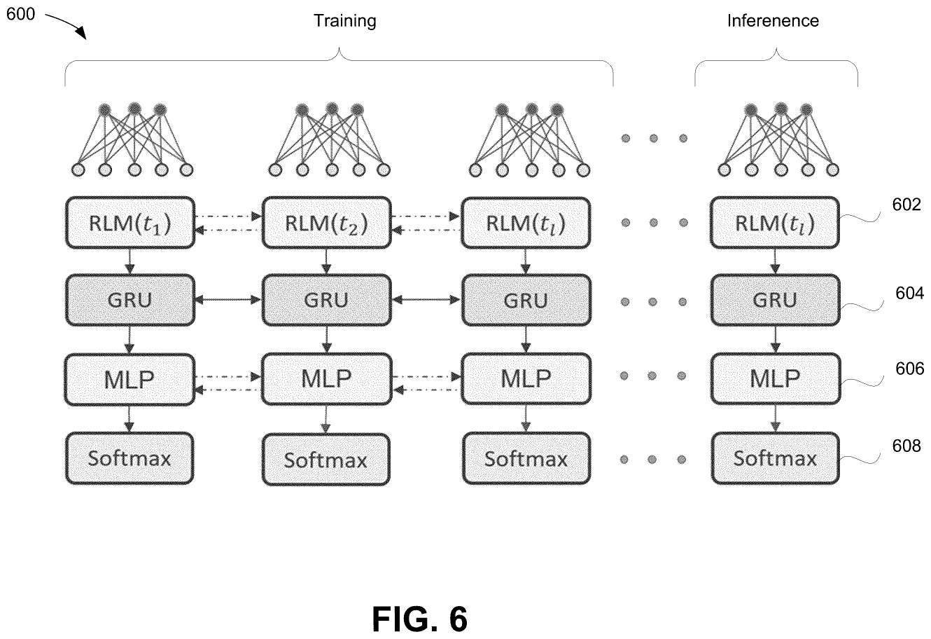

FIG. 6 is a schematic block diagram of a neural network 600 for solving MILP instances hybrid temporo-attentional branching in accordance with an embodiment the present disclosure. The neural network 600 comprises a representation learning module (RLM) 602, a Gated Recurrent Unit (GRU) module 604, an MLP layer 606 and a softmax output layer 608. The RLM 602 comprises the branching module 500 comprising the embedding layers 502 and two consecutive back-to-back GAT layers such as the GATs 504 and 508.

The GRU 604 is the module responsible for capturing the cross information between individual consecutive samples. GRU uses gates to control the flow of information but are faster to train due to their architecture. The GRU 604 captures hidden information in the correlation between sequential samples of an event. Therefore, using a GRU temporal information can be captured.

The RLM 602 generates representation vectors v_{i,t}, ∀i∈{1, . . . , n} for each MILP instance at time slot t. A buffer of size l×d is used to store l consecutive representation vectors for each node i∈{1, . . . , n} associated with past MILP instances. Once the buffer is full, the sequence of representation vectors is passed through the GRU 604 to deal with the temporal associations of the input sequence. Finally, l output vectors are outputted from the GRU 604 which will be passed through the MLP layer 606 with a softmax classification head 608.

At the t^{th} iteration the solver environment is at the state sₜ and the B&B search tree is encoded by the graph ( [symbol] , Cₜ, Vₜ, Eₜ). The solver at this time slot on the other hand, contains information about the past branching decisions (variables branched on), the primal bound and some other information about the current status of the B&B search tree. The bipartite graph representation of the solver state, however, encodes only the current B&B tree state and lacks the temporal information about the past node/edge features that have led the graph embeddings to the current state. To better imitate the solver agent in the solver environment, it is believed that monitoring the temporal variations of the encoded bipartite graph allows important information about the temporal interactions between the node/edge embeddings and their relative temporo-structural interplay to be captured. To this end, information about the temporal variations of the features associated with the B&B search tree and what decisions have led the B&B search tree to the current status can be injected into the model. To capture the temporal interaction between the graph nodes/edges, a multi-layer GRU recurrent neural network (RNN) is used to sequence of L consecutive variable embeddings v_{i,t}, ∀t∈{t−L+1, . . . , t}. Specifically for each variable node v_{i,t} in the input sequence and t∈{t−L+1, . . . , t}, the model computes:

z_{i,t}=σ_{g}(W_{z}v_{i,t}+U_{z}hₜ₋₁+b_{z}), (6.1)

r_{i,t}σ_{g}(Wᵣv_{i,t}+Uᵣh_{i,t-1}+bᵣ), (6.2)

ĥₜ=Øₕ(Wₕv_{i,t}+Uₕ(r_{i,t}⊙h_{i,t-1})+bₕ), (6.3)

h_{i,t}=(1−z_{i,t})⊙h_{i,t-1}+z_{i,t}⊙ĥₜ, (6.4)

where ⊙ is the Hadamard product operator, hₜ∈ [symbol] ^{d″} is the output vector, ĥₜ∈ [symbol] ^{d″} is the candidate activation vector, zₜ∈ [symbol] ^{d″} is the update gate vector, and finally rₜ∈ [symbol] ^{d″} is the reset gate vector. W, U∈ [symbol] ^{d″×d} and b∈ [symbol] ^{d″} are GRU parameter matrices and vector, and σ_{g} and ϕₕ are sigmoid and hyperbolic tangent activation functions.

The branching policy of the trained branching policy model performs variable selection via equation (7):

$${π}_{θ} ( {a}_{t}^{*} \vert {s}_{t} , … , {s}_{t + 1 - L} ) = {argmax}_{i} \frac{exp ( {F}_{V} ( {h}_{i , t} ) )}{{Σ}_{j = 1 \neq i}^{n} exp ( {F}_{V} ( {h}_{j , t} ) )} \qquad ( 7 )$$

where Fᵥ: [symbol] ^{d″}→ [symbol] is a multi-layer perceptron.

During training, model weights are updated via a gradient decent algorithm through minimizing the following loss function:

$$ℒ = - \frac{1}{L} {\sum }_{l = t - L + 1}^{t} log ( {π}_{θ} ( {a}_{l}^{*} \vert {s}_{l} , … , {s}_{l + 1 - L} ) ) \qquad ( 8 )$$

The following is a definition of all variables in the foregoing equations unless otherwise indicated: [symbol] is the bipartite graph representation of a MILP instance, C is the graph constraint feature matrix,V is the graph variable feature matrix, E is the graph edge feature matrix,c is the constraint feature vector,v is the variable feature vector,eᵢⱼ is the edge feature vector between variable node j and constraint node i, x is the optimization variables in the MILP, A is the MILP is the MILP coefficient matrix also known as the weighted adjacency matrix, b is the Offset vector for the MILP constraint equations,l is the lower bound constraint for the MILP variables vector, u is the upper bound constraint for the MILP variables vector, Θ is the attention module weight matrix, Ψ is the attention module weight matrix, αᵢⱼ is the attention weight between the neighboring nodes cᵢ, vⱼ, βⱼᵢ is the attention weight between the neighboring nodes cᵢ, vⱼ ϕ: Nonlinearity function in the attention module, z_{i,t} is the GRU update gate vector at time t for variable node i, is the GRU reset gate vector at time t for variable node i, hₜ is the GRU output vector at time t, ĥₜ is the GRU candidate activation vector at time t, U_{z}, Uᵣ, Uₕ, W_{z}, Wᵣ, Wₕ, b_{z}, bᵣ, bₕ are GRU parameter matrices, [symbol] (⋅) is a multi-layer perceptron, L is the GRU length, aₜ is the selected variable in the branching policy at time t, sₜ is the solver state at time t, π_{θ}(⋅) is the selection policy, with θ being its parameters, [symbol] is the Neighbors of node i, [symbol] is the Neighbors of node j, aᵥ is the attention coefficients vector for constraint feature vectors, and a, is the attention coefficients vector for variable feature vectors.

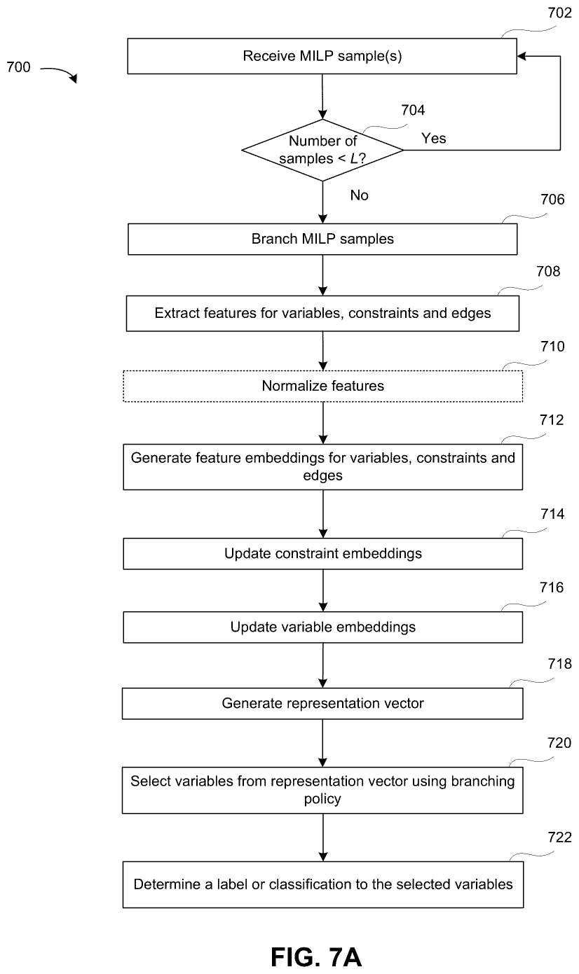

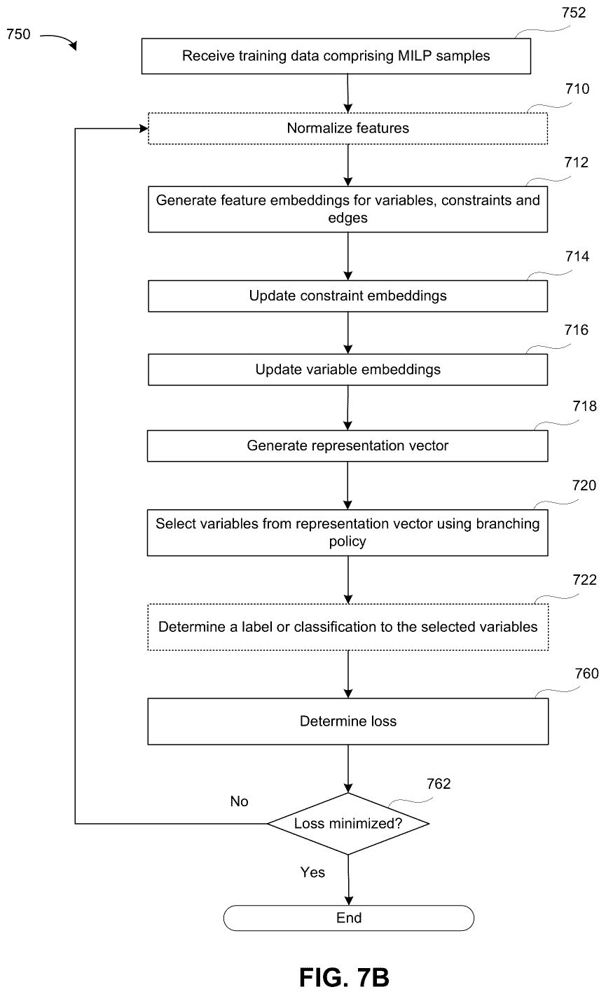

Referring now to FIG. 7A, a flowchart of method 700 for solving combinatorial optimization in accordance with one embodiment of the present disclosure will be described. The method 700 is performed at least in part by the neural network 600. The method 700 may be performed by one or more processing devices 102 of the computing system 100 which have been configured to provide the neutral network 600. The method 700 is used at inference time for a trained neutral network 600.

At step 702, one or more MILP samples for a MILP instance are received as input. The MILP instance represented by a bipartite graph, wherein the bipartite graph consists of a group of variable nodes, a group of constraint nodes, and edges between nodes in the group of variable nodes and the group of constraint nodes.

At step 704, it is determined whether the number of received MILP samples is less than L, where L is the number of MILP samples to perform an iteration. The value of L is variable. In response to a determination that the number of MILP samples is less than L, more MILP samples are received until a dataset of at least L MILP samples has been received. In response to a determination that the number of MILP samples is greater than or equal to L, the method 700 proceeds to step 706 and the solving continues.

At step 706, branching is performed for each of the MILP samples in the dataset in the dataset. The branching may be performed by an application solver which may be implemented in software, i.e. by a solver application separate from the neural network 600.

At step 708, features are extracted for variables, constraints, and edges of the each of the MILP samples in the dataset. The features are defined by feature vectors comprising a variable feature vector comprising variable features, a constraint feature vector comprising constraint features and an edge feature vector comprising edge features. The features may be extracted by a solver application. The variable features, constraint features and edge features may be extracted by the solver application using information about an application environment associated with the MILP instance. The application environment may comprise cellular networks, telecommunication networks, scheduling, renewable energy, aviation dispatching, or artificial intelligence and/or cloud resource allocation.

At step 710, the features are optionally normalized. For example, the variable features, constraint features and edge features may be normalized so that each feature value is between 0 and 1 using, for example, a normalization technique known in the art.

At step 712, feature embeddings are generated for variables, constraints, and edges of the each of the MILP samples in the dataset. In this step, variable embeddings, constraint embeddings and edge embeddings for the variable features, constraint features and edge features, respectively.

At step 714, the variable embeddings are passed to a first GAT of the neural network 600, such as the GAT 504, and the constraint embeddings are updated based on an attention of neighbouring nodes using the variable embeddings, constraint embeddings and edge embeddings. In at least some examples, the constraint embeddings are updated by the first GAT of the neural network by determining each constraint node in accordance with the following equation:

$${c}_{i , t} = \frac{1}{H} {\sum }_{h = 1}^{H} ( {α}_{ii}^{( h )} {Θ}_{c}^{( h )} {c}_{t , t} + {\sum }_{i ∈ {N}_{i}} {α}_{ij}^{( h )} {Θ}_{v}^{( h )} {v}_{j , t} ) \\ where \\ {α}_{ij}^{( h )} = \frac{exp ( {a}_{c}^{{( h )}^{T}} LeakyReLU ( [ {Θ}_{c}^{( h )} {c}_{i , t} \vert \vert {Θ}_{v}^{( h )} {v}_{j , t} \vert \vert {Θ}_{e}^{( h )} {e}_{ij , t} ] ) )}{{Σ}_{k ∈ {N}_{i} ⋃ \{ i \}} exp ( {a}_{c}^{{( h )}^{T}} LeakyReLU ( [ {Θ}_{c}^{( h )} {c}_{i , t} \vert \vert {Θ}_{v}^{( h )} {v}_{k , t} \vert \vert {Θ}_{e}^{( h )} {e}_{ik , t} ] ) )} ,$$

where Θᵥ^{(h)}, Θ_{c}^{(h)}, Θₑ^{(h)}∈ [symbol] ^{d′×d} are learned weights,
where a_{c}^{(h)} is an attention coefficients vector with a_{c}^{(h)}∈ [symbol] ^{3d′}.

At step 716, the constraint embeddings are passed to a second GAT of the neural network 600, such as the GAT 508, and the variable embeddings are updated based on an attention of neighbouring nodes using the variable embeddings, updated constraint embeddings and edge embeddings. In at least some examples, the variable embeddings are updated by the second GAT of the neural network by determining each variable node in accordance with the following equation:

$${v}_{j , t} = \frac{1}{H} {\sum }_{h = 1}^{H} ( {β}_{jj}^{( h )} {Ψ}_{v}^{( h )} {v}_{j , t} + {\sum }_{i ∈ {N}_{j}} {β}_{ji}^{( h )} {Ψ}_{c}^{( h )} {c}_{i , t} ) \\ where \\ {β}_{ji}^{( h )} = \frac{exp ( {a}_{v}^{{( h )}^{T}} LeakyReLU ( [ {Ψ}_{v}^{( h )} {v}_{j , t} \vert \vert {Ψ}_{c}^{( h )} ∈ {ℝ}^{d \times d} {c}_{i , t} \vert \vert {Ψ}_{ve}^{( h )} ∈ {ℝ}^{d \times d} {e}_{ji , t} ] ) )}{{Σ}_{k ∈ {N}_{j} ⋃ \{ j \}} exp ( {a}_{v}^{{( h )}^{T}} LeakyReLU ( [ {Ψ}_{v}^{( h )} {v}_{j , t} \vert \vert {Ψ}_{c}^{( h )} ∈ {ℝ}^{d \times d} {c}_{i , t} \vert \vert {Ψ}_{ve}^{( h )} ∈ {ℝ}^{d \times d} {e}_{ji , t} ] ) )} ,$$

where Ψ_{c}^{(h)}∈ [symbol] ^{d×d′} is a learned weight,
where Ψᵥ^{(h)}∈ [symbol] ^{d×d} is a learned weight,
where Ψₑ^{(h)}∈ [symbol] ^{d×d} is a learned weight,
where aᵥ^{(h)}∈ [symbol] ^{3d} is a learned attention coefficients vector, the variable feature nodes v_{i,t} represent each variable in the bipartite graph ∀i∈[0,n], wherein the variable feature nodes are encoded representations regarding the graph structure and node embeddings of the MILP instance at a state sₜ.

At step 718, a representation vector is generated by a Gated Recurrent Unit (GRU) 604 of the neural network 600, based on the updated variable embeddings for an input sequence consisting of all MILP samples in the dataset. In at least some examples, the GRU is a multi-layer GRU recurrent neural network (RNN). In at least some examples, the representation vector is generated by the GRU of the neural network by, for each variable node v_{i,t} in the input sequence and t∈{t−L+1, . . . , t}, computing the following equations:

z_{i,t}=σ_{g}(W_{z},v_{i,t}+U_{z}hₜ₋₁+b_{z}),

r_{i,t}=σ_{g}(Wᵣv_{i,t}+Uᵣh_{i,t-1}+bᵣ),

ĥₜ=Øₕ(Wₕv_{i,t}+Uₕ(r_{i,t}⊙h_{i,t-1})+bₕ),

h_{i,t}=(1−z_{i,t})⊙h_{i,t-1}+z_{i,t}└ĥₜ,

where L is a GRU length, ⊙ is a Hadamard product operator, hₜ is the representation vector, ĥₜ∈ [symbol] ^{d″} is a candidate activation vector, zₜ∈ [symbol] ^{d″} is a update gate vector, rₜ∈ [symbol] ^{d″} is a reset gate vector, W, U∈ [symbol] ^{d″×d} and b∈ [symbol] ^{d″} are GRU parameter matrices and vector respectively, and σ_{g} and ϕₕ are sigmoid and hyperbolic tangent activation functions.

At step 720, variables for a first MILP sample in the dataset are selected from the representation vector in accordance with a branching policy, wherein the selected variables are to be applied to a system. In at least some examples, the variables for the first MILP sample are selected from the representation vector in accordance with the branching policy with the following equation:

$${π}_{θ} ( {a}_{t}^{*} \vert {s}_{t} , … , {s}_{t + 1 - L} ) = {argmax}_{i} \frac{exp ( {F}_{V} ( {h}_{i , t} ) )}{{Σ}_{j = 1 \neq i}^{n} exp ( {F}_{V} ( {h}_{j , t} ) )} ,$$

where Fᵥ: [symbol] ^{d″}→ [symbol] is a multi-layer perceptron.

At step 722, a label or classification may be determined based on the selected variables using the softmax output layer 608 of the neural network 600.

The method may further comprise outputting the selected variables (or classification or label) to an external system for application thereon or applying the selected variables to a system, such as a communication system or computing system. In some examples, the selected variables associated with and are applied to a system for associated with cellular networks, telecommunication networks, scheduling, renewable energy, aviation dispatching, or artificial intelligence and/or cloud resource allocation. In some examples, the selected variables are applied to distribute available frequencies across antennas in a cellular network so as to connect mobile equipment and that interference between the antennas in the cellular network is minimized. In some examples, the selected variables are applied to a determine network lines of a telecommunication network so that so that a predefined set of communication requirements are met and a total cost of the telecommunication network is minimized. In some examples, wherein the selected variables are applied to cost efficient deep learning job allocation (CE-DLA), wherein energy consumption of deep learning clusters is minimized while maintaining an overall system performance within an acceptable threshold.

Referring now to FIG. 7B, a flowchart of method 750 for training a neural network 600 to solve combinatorial optimization in accordance with one embodiment of the present disclosure will be described. The method 750 may be performed by one or more processing devices 102 of the computing system 100 which have been configured to provide the neutral network 600. The method 750 is a form of supervised learning.

At step 752, a set of training data in the form of a plurality of MILP samples are received. The training data is obtained for a number of MILP instances. For each MILP instance, a number of MILP samples are obtained by extracting features, making branching decisions and optionally determining a label or class for via a softmax output layer. The results are stored as training data. It is noted that each MILP sample is associated with a predetermined set of selected variables and optionally a label or class. The goal of the training is to train a neural network to make the same choices at each branching node using the same feature set so that it can be used with other MILP instances. Next, steps 710-720 and optionally step 722 are performed in accordance with the method 700.

Next, at step 760 loss is determined based on the selected variables determined during a training iteration (or classification or label) and the predetermined set of selected variables (or classification or label). In some examples, the loss is determined in accordance with the following equation:

$$ℒ = - \frac{1}{L} {\sum }_{l = t - L + 1}^{t} log ( {π}_{θ} ( {a}_{l}^{*} \vert {s}_{l} , … , {s}_{l + 1 - L} ) ) \qquad ( 8 )$$

The weights of the neural network 600 are updated via a gradient decent algorithm until the loss is minimized, i.e. the weights of one or more of the GAT 504, GAT 508 or GRU 602 are updated via a gradient decent algorithm until the loss is minimized. At step 762, it is determined whether the loss is minimized. In response to a determination that the loss is not minimized, processing returns to step 710 for a further iteration. In response to a determination that the loss is minimized, the method 750 ends.

As noted above, the method of the present disclosure can be used to solve mixed integer linear programs (MILP) The method of the present disclosure can be used to address a variety of problems and applications relating to, among other things, cellular networks, telecommunication networks, scheduling (e.g., in transportation industry), renewable energy, aviation dispatching, and AI and/or cloud resource allocation (for example, for minimizing the GPU cluster energy consumption with some constraints on the performance).

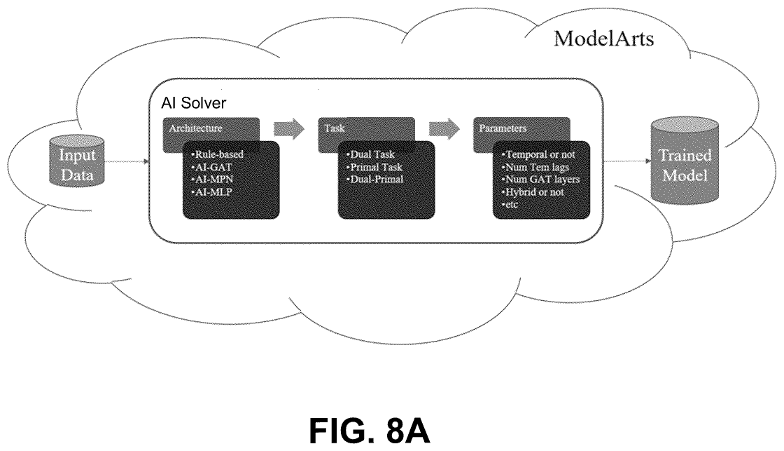

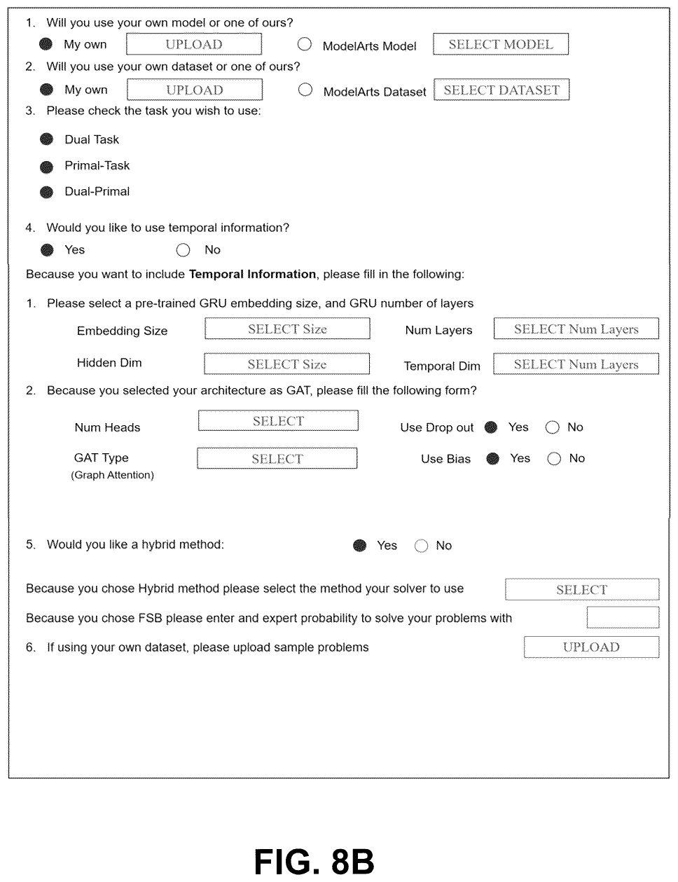

The methods of the present disclosure can be integrated into solver software such as an AI solver. The methods of the present disclosure may be provided as a submodule of a solver. The methods of the present disclosure may can add to the capabilities of the solver, for example, in cases where statistical properties of data is useable. The AI module can be used in a vast majority of cases where a dataset is available previously. FIG. 8A is schematic block diagram of AI solver for solving MILPs using hybrid temporo-attentional branching in accordance with an embodiment of the present disclosure. To integrate into the solver, the method could be added as a drop-down option in training/inference services, for example as an AI assistant option for the solver. FIG. 8B is an example user interface of a cloud AI based system for solving MILPs using hybrid temporo-attentional branching in accordance with an embodiment of the present disclosure that provides an integration workflow. The user interface comprises a number of questions or prompts. A user may be provided with a choice of an architecture to solve MILPs between the solver itself and different versions of AI-based techniques. The task for the MILPs the user wishes to solve as well as any parameters used for training may be specified. The training service may be provided as a Software-as-a Service (SaaS) solution provided by a cloud service provided for training an AI-solver.

In prompt 1, the user is asked to specify a model to be used be the solver. In prompt 2, the user is asked to specify the dataset to be used. In prompt 3, the user is asked to specify the task the user would like to perform, i.e. dual task, primal-task, or dual-primal. In prompt 4, the user is asked to specify if they want to include temporal information. If the users specifies that temporal information is to be included (e.g., by selecting yes) then the method in which way the dataset is generated from the provided MILP instances would be different and sequential samples should be generated to train the hybrid TGAT model. In prompt 4.1, the parameters of GRU may be tuned. If the user selects GAT-only as the model then the user is asked about the parameters of the GAT. Finally, in prompt 5 the user is asked to specify if they would prefer a hybrid method where the solver automatically switches between ruled-based methods and AI-assisted methods or not.

The steps (also referred to as operations) in the flowcharts and drawings described herein are for purposes of example only. There may be many variations to these steps/operations without departing from the teachings of the present disclosure. For instance, the steps may be performed in a differing order, or steps may be added, deleted, or modified, as appropriate.

### Experiments

A set of experiments and ablations were performed to test the neural network, method, systems and media of the present disclosure using SCIP 7.0 optimization suite as a backend solver along with the Ecole library to run the experiments. A Linux server with 9 CPU cores and 64 GB RAM and a V100 GPU card with 32 GB memory were used. For both generating the training set and solving the MILP instances, a solver time limit of 3,600 seconds was used unless otherwise stated.

The neural network, method, systems and media of the present disclosure were evaluated on six different datasets that cover a good range of variations in terms of difficulty among the available MILP benchmarks: Benchmark 1, set covering: with 1000 variables generated based on the work of Balas and Ho in E. Balas and A. Ho, “Set covering algorithms using cutting planes, heuristics, and subgradient optimization: a computational study,” in Combinatorial Optimization. Springer, 1980, pp. 37-60. Following M. Gasse, D. Chételat, N. Ferroni, L. Charlin, and A. Lodi, “Exact combinatorial optimization with graph convolutional neural networks,” Advances in Neural Information Processing Systems, vol. 32, 2019, the training was performed on easy MILP samples with only 500 constraints, and the trained model was evaluated on the MILP instances with 500 (Easy), 1000 (Medium), and 1500 (Hard) constraints; Benchmark 2, combinatorial auctions: Similar to the approach in “Exact combinatorial optimization with graph convolutional neural networks,” training was performed on instances with 100 variables (items) vs 500 constraints (bids), and the trained model was evaluated on three sets of Easy, Medium and Hard problems representing item-bid pairs of (100, 500), (200, 1000), and (300, 1500) respectively. This dataset is generated according to K. Leyton-Brown, M. Pearson, and Y. Shoham, “Towards a universal test suite for combinatorial auction algorithms,” in Proceedings of the 2nd ACM conference on Electronic commerce, 2000, pp. 66-76; Benchmark 3, capacitated facility locations: generated using the method in G. Cornuéjols, R. Sridharan, and J.-M. Thizy, “A comparison of heuristics and relaxations for the capacitated plant location problem,” European journal of operational research, vol. 50, no. 3, pp. 280-297, 1991, with 100 variables (facilities). The Easy, Medium, and Hard problems each have 100, 200 and 400 constraints (customers), respectively. As a routine procedure, training was performed on easy samples and evaluated on the three mentioned MILP instance categories regarding their level of difficulty. Benchmark 4, maximum independent set: generated according to D. Bergman, A. A. Cire, W.-J. Van Hoeve, and J. Hooker, Decision diagrams for optimization. Springer, 2016, vol. 1. It consists of maximum independent set instances on Erdös-Rényi random graphs (“Exact combinatorial optimization with graph convolutional neural networks”), with affinity set to 4. Similar to the previous benchmarks, training was performed on easy samples with 500 nodes and evaluate on instances with 500 (Easy), 1000 (Medium) and 1500 (Hard) nodes. Benchmark 5, work load appointments (Load Balancing): This dataset represents data associated with allocating workloads (data streams/computational assignments) to the minimum number of workers (servers/GPU clusters) possible. This dataset contains 9900 train, 100 validation, and 100 test MILP instances (See M. Gasse, Q. Cappart, J. Charfreitag, L. Charlin, D. Chetelat, A. Chmiela, J. Dumouchelle, A. Gleixner, A. M. Kazachkov, E. Khalil, P. Lichocki, A. Lodi, M. Lubin, C. J. Maddison, C. Morris, D. J. Papageorgiou, A. Parjadis, S. Pokutta, A. Prouvost, L. Scavuzzo, G. Zarpellon, L. Yang, S. Lai, A. Wang, X. Luo, X. Zhou, H. Huang, S. Shao, Y. Zhu, D. Zhang, T. Quan, Z. Cao, Y. Xu, Z. Huang, S. Zhou, C. Binbin, H. Ming-gui, H. Hao, Z. Zhiyu, A. Zhiwu, and M. Kun, “The machine learning for combinatorial optimization competition (ml4co): Results and insights,” arXiv preprint: 2203.02433, 2022). Benchmark 6, maritime Inventory Routing: The MILP instances associated to this dataset are created according to publicly released information on global bulk shipping (See D. J. Papageorgiou, G. L. Nemhauser, J. Sokol, M.-S. Cheon, and A. B. Keha, “Mirplib—a library of maritime inventory routing problem instances: Survey, core model, and benchmark results,” European Journal of Operational Research, vol. 235, no. 2, pp. 350-366, 2014). This benchmark contains 98 training, 20 validation and 20 test MILP instances.

It is noted that the first four benchmark datasets are commonly used. However, the individual MILP problem instances are created each time based on the problem structure/formulation. This makes it difficult to compare the results of different studies. The last two benchmark datasets were provided in the form of problem instances in mps files and are therefore more convenient for cross-studies comparisons. Nevertheless, since solvers rely heavily on the underlying hardware of the testing machine (CPU, memory, GPU, etc.), a truly fair evaluation is only achieved when all baseline methods are run on a same machine with the same set of MILP instance files, and therefore the performance evaluations were so performed.

The results were compared with the SCIP internal branching solutions, FSB, state-of-the-art human designed reliability pseudocost branching (RPB) as described in T. Achterberg, T. Koch, and A. Martin, “Branching rules revisited,” Operations Research Letters, vol. 33, no. 1, pp. 42-54, 2005, and finally the pseudo cost branching rule (Pb). Additionally, for the first four benchmarks, the results were compared with the GCNN approach of Gasse in “Exact combinatorial optimization with graph convolutional neural networks” LambdaMART of Burges in C. J. Burges, “From ranknet to lambdarank to lambdamart: An overview,” Learning, vol. 11, no. 23-581, p. 81, 2010, SVM Rank of Khalil in E. Khalil, P. Le Bodic, L. Song, G. Nemhauser, and B. Dilkina, “Learning to branch in mixed integer programming,” in Proceedings of the AAAI Conference on Artificial Intelligence, vol. 30, no. 01, 2016, and finally the ExtraTrees method proposed by P. Geurts, D. Ernst, and L. Wehenkel, “Extremely randomized trees,” Machine learning, vol. 63, no. 1, pp. 3-42, 2006. For this, the code base provided by P. Gupta, M. Gasse, E. Khalil, P. Mudigonda, A. Lodi, and Y. Bengio, “Hybrid models for learning to branch,” Advances in neural information processing systems, vol. 33, pp. 18 087-18 097, 2020 was used in the solver environment. For the last two benchmarks, the results were compared with the internal branching rules of SCIP and also the method proposed by Z. Cao, Y. Xu, Z. Huang, and S. Zhou, “Ml4co-kida: Knowledge inheritance in dataset aggregation,” arXiv preprint arXiv:2201.10328, 2022, and A. Banitalebi-Dehkordi and Y. Zhang, “Ml4co: Is gcnn all you need? graph convolutional neural networks produce strong baselines for combinatorial optimization problems, if tuned and trained properly, on appropriate data,” arXiv preprint arXiv:2112.12251, 2021.

For training the temporo-attentional branching policy of the present disclosure, a training data collection phase was run in which the instances are solved with a time-limit of 3,600 seconds using the full strong branching rule from SCIP 7.0 as an expert agent. For each benchmark, 160 k samples were generated from the training set instances for all the benchmarks except for Maritime inventory routing dataset that generated only 5.7 k MILP samples due to lack of enough training MILP instances. In particular, the states of the first L consecutive episodes of each MILP instance were recorded in the form of bipartite graph representations along with the branching choices associated to each episode. The agents are then trained with the collected datasets.

For the first 4 benchmarks, the same evaluation metric as in “Exact combinatorial optimization with graph convolutional neural networks” was used. Specifically, the report (1) Time: the 1-shifted geometric mean of solving time across the Easy, Medium, and Hard segments of each benchmark, (2) Node: 1-shifted geometric mean of B&B node count of the instances solved by each strategy, and (3) Win: number of times each branching agent wins the other strategies based on the solving time.

It is noted that the three metrics mentioned above, each one alone, does not fully capture the solvers performance since for each MILP instance both the time taken to solve and the actual solution value (gap) in a given time are important. In other words, a good solution should be able to reduce the gap to the optimal value in a short amount of time. Therefore, it makes sense to include the rate with which the gap is reduced in the evaluation metric. To this end, a reward metric is incorporated to address this issue. This metric is defined as:

R=∫ₜ₌₀^{T}zₜ*dt−Tc^{T}x* (9)

where zₜ* is the best dual bound at time t, x* is the optimal solution and T is the time limit. The reward, within a time limit of T, is maximized if the gap between the optimal solution and the dual bound is decreased with a higher rate during consecutive episodes of branching process.

For the last two benchmarks, a dual integral reward (See, for example, T. Zhang, A. Banitalebi-Dehkordi, and Y. Zhang, “Deep reinforcement learning for exact combinatorial optimization: Learning to branch,” 26^{th} International Conference on Pattern Recognition, ICPR, 2022) which measures the area bounded by the solver's dual bound and the optimal solution.

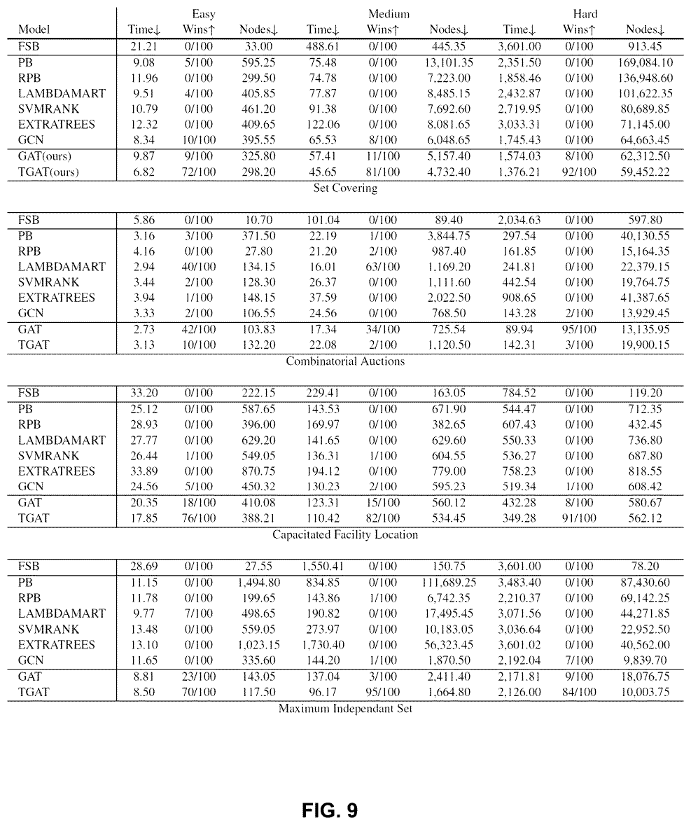

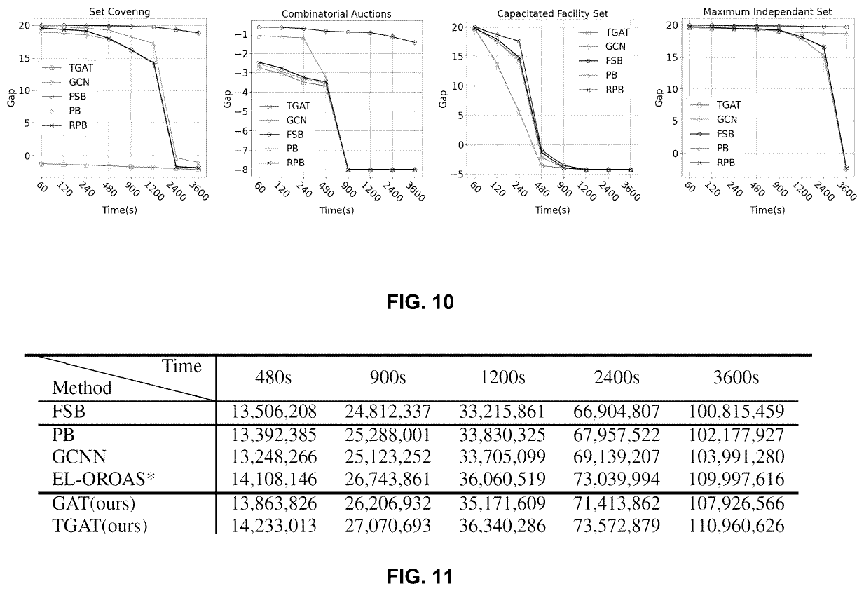

Results and discussions: FIG. 9 shows the results on the first 4 benchmark datasets compared to the baselines in three segments of the datasets, i.e. Easy, Medium, and Hard instances. In particular, FIG. 9 shows the evaluation of AI-assisted policies and heuristics-based branchers for sets of easy, medium, and hard MILP instances in terms of solving time, ratio of number of wins (fastest method) over total number of solved MILP instances, and number of nodes solved by each method. For the temporo-attentional (TGAT) method of the present disclosure, the embedding dimension d=d′=32 was used and the number of L=4 temporal lags was used. The attention module has only 2 heads per node. As it can be seen from the results, the TGAT method outperforms the other baselines in terms of the evaluation metrics Time, Nodes and Wins for the Set covering, Capacitated facility locations, and Maximum independent set benchmarks. In all cases, the TGAT method/model outperforms the baseline GCNN method. Amongst other baselines LambdaMart performs better in Easy evaluation instances. FIG. 10 shows the dual-primal gap across the baselines and the TGAT method. In particular, FIG. 10 shows an average dual-primal gap in logarithmic scale vs. solving time-limit in seconds. As observed, the TGAT method performs better than the other internal branching rules as well as the GCNN baseline in closing the gap between the dual bound and the primal bound during a given solving time limit. Among the heuristic rules FSB is the slowest and RPB is the fastest in closing the gap.

Ablation, TGAT vs GAT: To evaluate the effect of incorporating the temporal characteristics of the variable embeddings, a GAT-only agent was evaluated in the experiments. As it can be seen in FIG. 9, the TGAT method of the present disclosure outperforms the GAT-only agent except for the Combinatorial auctions dataset. It is believed that since this benchmark has relatively smaller MILP instances, adding a GRU structure to the model increases the complexity and thus the inference latency. Since solving a MILP instance is about a combination of accuracy and latency, in smaller sets such as the Combinatorial auctions, latency wins. However, the GAT-only version still outperforms other branching baselines.

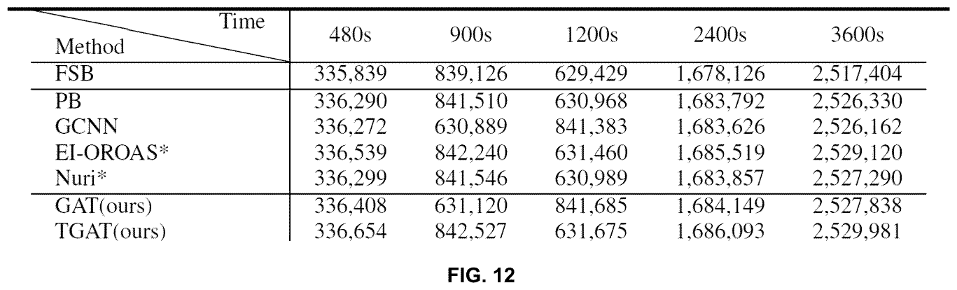

Dual integral reward: FIGS. 11 and 12 show the dual integral reward metric mentioned above for the load balancing and the maritime inventory routing datasets/benchmarks respectively. We evaluate the results on the same test set used by in the ML4CO challenge. The results are compared with the SCIP's internal branching rules, the GCNN in “Exact combinatorial optimization with graph convolutional neural networks”, and team EI-OROAS in “Ml4co: Is gcnn all you need? graph convolutional neural networks produce strong baselines for combinatorial optimization problems, if tuned and trained properly, on appropriate data”. The results show that both of the GAT and TGAT methods and structures outperform the GCNN baseline in terms of the dual integral reward. Additionally, the TGAT method also shows a strong performance compared to other baselines.

### General

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A computer-implemented method for solving combinatorial optimization using a neural network, comprising:
receiving a dataset comprising a first mixed integer linear program (MILP) sample and a predetermined number of other MILP samples of a MILP instance represented by a bipartite graph, wherein the bipartite graph consists of a group of variable nodes, a group of constraint nodes, and edges between nodes in the group of variable nodes and the group of constraint nodes, each MILP sample comprising a variable feature vector comprising variable features, a constraint feature vector comprising constraint features and an edge feature vector comprising edge features;
for each MILP sample in the dataset:
generating variable embeddings, constraint embeddings and edge embeddings for the variable features, constraint features and edge features, respectively;
updating, by a first graph attention network (GAT) of the neural network, the constraint embeddings based on an attention of neighbouring nodes based on the variable embeddings, constraint embeddings and edge embeddings; and
updating, by a second GAT of the neural network, the variable embeddings based on an attention of neighbouring nodes based on the variable embeddings, updated constraint embeddings and edge embeddings;
generating, by a Gated Recurrent Unit (GRU) of the neural network, a representation vector based on the updated variable embeddings for an input sequence consisting of all MILP samples in the dataset; and
selecting variables for the first MILP sample from the representation vector in accordance with a branching policy.

2. The method of claim 1, wherein the constraint embeddings are updated by the first GAT of the neural network by determining each constraint node in accordance with the following equation:
$${c}_{i , t} = \frac{1}{H} {\sum }_{h = 1}^{H} ( {α}_{ii}^{( h )} {Θ}_{c}^{( h )} {c}_{t , t} + {\sum }_{i ∈ {N}_{i}} {α}_{ij}^{( h )} {Θ}_{v}^{( h )} {v}_{j , t} ) \\ where \\ {α}_{ij}^{( h )} = \frac{exp ( {a}_{c}^{{( h )}^{T}} LeakyReLU ( [ {Θ}_{c}^{( h )} {c}_{i , t} \vert \vert {Θ}_{v}^{( h )} {v}_{j , t} \vert \vert {Θ}_{e}^{( h )} {e}_{ij , t} ] ) )}{{Σ}_{k ∈ {N}_{i} ⋃ \{ i \}} exp ( {a}_{c}^{{( h )}^{T}} LeakyReLU ( [ {Θ}_{c}^{( h )} {c}_{i , t} \vert \vert {Θ}_{v}^{( h )} {v}_{k , t} \vert \vert {Θ}_{e}^{( h )} {e}_{ik , t} ] ) )} ,$$
where Θᵥ^{(h)}∈ [symbol] ^{d′×d} is a learned weight,
where, Θ_{c}^{(h)}∈ [symbol] ^{d′×d} is a learned weight,
where, Θₑ^{(h)}∈ [symbol] ^{d′×d} is a learned weight, and
where a_{c}^{(h)} is an attention coefficients vector with a_{c}^{(h)}∈ [symbol] ^{3d′}.

3. The method of claim 1, wherein the variable embeddings are updated by the second GAT of the neural network by determining each variable node in accordance with the following equation:
$${v}_{j , t} = \frac{1}{H} {\sum }_{h = 1}^{H} ( {β}_{jj}^{( h )} {Ψ}_{v}^{( h )} {v}_{j , t} + {\sum }_{i ∈ {N}_{j}} {β}_{ji}^{( h )} {Ψ}_{c}^{( h )} {c}_{i , t} ) \\ where \\ {β}_{ji}^{( h )} = \frac{exp ( {a}_{v}^{{( h )}^{T}} LeakyReLU ( [ {Ψ}_{v}^{( h )} {v}_{j , t} \vert \vert {Ψ}_{c}^{( h )} ∈ {ℝ}^{d \times d} {c}_{i , t} \vert \vert {Ψ}_{ve}^{( h )} ∈ {ℝ}^{d \times d} {e}_{ji , t} ] ) )}{{Σ}_{k ∈ {N}_{j} ⋃ \{ j \}} exp ( {a}_{v}^{{( h )}^{T}} LeakyReLU ( [ {Ψ}_{v}^{( h )} {v}_{j , t} \vert \vert {Ψ}_{c}^{( h )} ∈ {ℝ}^{d \times d} {c}_{i , t} \vert \vert {Ψ}_{ve}^{( h )} ∈ {ℝ}^{d \times d} {e}_{ji , t} ] ) )} ,$$
where Ψ_{c}^{(h)}∈ [symbol] ^{d×d′} is a learned weight,
where Ψᵥ^{(h)}∈ [symbol] ^{d×d} is a learned weight,
where Ψₑ^{(h)}∈ [symbol] ^{d×d} is a learned weight,
where aᵥ^{(h)}∈ [symbol] ^{3d} is a learned attention coefficients vector, the variable feature nodes v_{i,t} represent each variable in the bipartite graph ∀i∈[0,n], wherein the variable feature nodes are encoded representations regarding the graph structure and node embeddings of the MILP instance at a state sₜ.

4. The method of claim 1, wherein the GRU is a multi-layer GRU recurrent neural network (RNN).

5. The method of claim 1, wherein the representation vector is generated by the GRU of the neural network by, for each variable node v_{i,t} in the input sequence and t∈{t−L+1, . . . , t}, computing the following equations:
z_{i,t}=σ_{g}(W_{z},v_{i,t}+U_{z}hₜ₋₁+b_{z}),
r_{i,t}=σ_{g}(Wᵣv_{i,t}+Uᵣh_{i,t-1}+bᵣ),
ĥₜ=Øₕ(Wₕv_{i,t}+Uₕ(r_{i,t}⊙h_{i,t-1})+bₕ),
h_{i,t}=(1−z_{i,t})⊙h_{i,t-1}+z_{i,t}└ĥₜ,
where L is a GRU length, ⊙ is a Hadamard product operator, hₜ∈ [symbol] ^{d″} is the representation vector, ĥₜ∈ [symbol] ^{d″} is a candidate activation vector, zₜ∈ [symbol] ^{d″} is an update gate vector, rₜ∈ [symbol] ^{d″} is a reset gate vector, W, U∈ [symbol] ^{d″×d} and b∈ [symbol] ^{d″} are GRU parameter matrices and vector respectively, and σ_{g} and ϕₕ are sigmoid and hyperbolic tangent activation functions.

6. The method of claim 1, wherein the variables for the first MILP sample are selected from the representation vector in accordance with the branching policy with the following equation:
$${π}_{θ} ( {a}_{t}^{*} \vert {s}_{t} , … , {s}_{t + 1 - L} ) = {argmax}_{i} \frac{exp ( {F}_{V} ( {h}_{i , t} ) )}{{Σ}_{j = 1 \neq i}^{n} exp ( {F}_{V} ( {h}_{j , t} ) )} ,$$
where Fᵥ: [symbol] ^{d″}→ [symbol] is a multi-layer perceptron.

7. The method of claim 1, comprising:
extracting the variable features, constraint features and edge features from the MILP samples.

8. The method of claim 7, wherein the variable features, constraint features and edge features are extracted using information about an application environment associated with the MILP instance.

9. The method of claim 8, wherein the application environment comprises cellular networks, telecommunication networks, scheduling, renewable energy, aviation dispatching, or artificial intelligence and/or cloud resource allocation.

10. The method of claim 7, wherein the variable features, constraint features and edge features are extracted by a solver application separate from the neural network.

11. The method of claim 1, comprising:
normalizing the dataset prior to generating the variable embeddings, constraint embeddings and edge embeddings for the variable features, constraint features and edge features, respectively.

12. The method of claim 1, comprising:
determining a label or classification based on the selected variables.

13. The method of claim 1, further comprising:
outputting the selected variables or a label or classification determined based on the selected variables to an external system for application thereon.

14. The method of claim 1, further comprising:
applying the selected variables or a label or classification determined based on the selected variables to a system.

15. The method of claim 14, wherein the selected variables or label or classification determined based on the selected variables are applied to a system for associated with cellular networks, telecommunication networks, scheduling, renewable energy, aviation dispatching, artificial intelligence and/or cloud resource allocation.

16. The method of claim 14, wherein the selected variables or label or classification determined based on the selected variables are applied to distribute available frequencies across antennas in a cellular network so as to connect mobile equipment and that interference between the antennas in the cellular network is minimized.

17. The method of claim 14, wherein the selected variables or label or classification determined based on the selected variables are applied to a determine network lines of a telecommunication network so that a predefined set of communication requirements are met and a total cost of the telecommunication network is minimized.

18. The method of claim 14, wherein the selected variables or label or classification determined based on the selected variables are applied to cost efficient deep learning job allocation (CE-DLA), wherein energy consumption of deep learning clusters is minimized while maintaining an overall system performance within an acceptable threshold.

19. A computing device for solving combinatorial optimization, the computing device comprising:
one or more processor configured to:
receive a dataset comprising a first mixed integer linear program (MILP) sample and a predetermined number of other MILP samples of a MILP instance represented by a bipartite graph, wherein the bipartite graph consists of a group of variable nodes, a group of constraint nodes, and edges between nodes in the group of variable nodes and the group of constraint nodes, each MILP sample comprising a variable feature vector comprising variable features, a constraint feature vector comprising constraint features and an edge feature vector comprising edge features;
for each MILP sample in the dataset:
generate variable embeddings, constraint embeddings and edge embeddings for the variable features, constraint features and edge features, respectively;
update, by a first graph attention network (GAT) of a neural network, the constraint embeddings based on an attention of neighbouring nodes using the variable embeddings, constraint embeddings and edge embeddings; and
update, by a second GAT of the neural network, the variable embeddings based on an attention of neighbouring nodes using the variable embeddings, updated constraint embeddings and edge embeddings;
generate, by a Gated Recurrent Unit (GRU) of the neural network, a representation vector based on the updated variable embeddings for an input sequence consisting of all MILP samples in the dataset; and
select variables for the first sample from the representation vector in accordance with a branching policy.

20. A non-transitory machine-readable medium having tangibly stored thereon executable instructions for execution by one or more processors, wherein the executable instructions, in response to execution by the one or more processors, cause the one or more processors to:
receive a dataset comprising a first mixed integer linear program (MILP) sample and a predetermined number of other MILP samples of a MILP instance represented by a bipartite graph, wherein the bipartite graph consists of a group of variable nodes, a group of constraint nodes, and edges between nodes in the group of variable nodes and the group of constraint nodes, each MILP sample comprising a variable feature vector comprising variable features, a constraint feature vector comprising constraint features and an edge feature vector comprising edge features;
for each MILP sample in the dataset:
generate variable embeddings, constraint embeddings and edge embeddings for the variable features, constraint features and edge features, respectively;
update, by a first graph attention network (GAT) of a neural network, the constraint embeddings based on an attention of neighbouring nodes using the variable embeddings, constraint embeddings and edge embeddings; and
update, by a second GAT of the neural network, the variable embeddings based on an attention of neighbouring nodes using the variable embeddings, updated constraint embeddings and edge embeddings;
generate, by a Gated Recurrent Unit (GRU) of the neural network, a representation vector based on the updated variable embeddings for an input sequence consisting of all MILP samples in the dataset; and
select variables for the first MILP sample from the representation vector in accordance with a branching policy.
